(19) United States
(12) Patent Application Publication
(10) Pub. No.: US 2013/0008465 A1
(43) Pub. Date: Jan. 10, 2013

(54) FIBER COLLECTING CLEANING MAT

(76) Inventor: Valerie Ray, Little Elm, TX (US)

(21) Appl. No.: 13/176,507

(22) Filed: Jul. 5, 2011

(51) Int. Cl. A47L 25/00; B08B 7/00

(52) U.S. Cl. 134/6; 15/104.002

(57) ABSTRACT

A cleaning mat for adhesively removing hair or lint or both from an environmental surface, and method of using the cleaning mat. The mat has a first surface which is adapted to receive and cooperate with manual pressure, and an opposed second surface which bears a slightly tacky material and a removable, reinstallable liner. The mat is briefly pressed against the environmental surface by manual contact and removed therefrom. Manual contact may be at an acute angle to the plane of the mat, whereupon frictional characteristics of the mat will oppose ineffectual sliding of the hand over the mat. The mat is flexible and may be pressed into conforming engagement with curved environmental surfaces. The mat may be protected by the liner when not in use. Mats may be provided in stacks suitably enclosed for retail distribution.

### FIELD OF THE INVENTION

The present invention relates to cleaning, and more particularly, to a device for picking fibers such as hair and lint by adherence.

### BACKGROUND OF THE INVENTION

Among the most frequently encountered forms of contaminants which settle on household surfaces are fibrous waste such as human and pet hair and lint from fabric. While these forms of waste are not particularly hazardous, they are still objectionable, and must be cleaned from household surfaces periodically. Fibrous waste may not only settle on household surfaces, it may also cling by static electrical attraction. Moreover, there are many types of household surfaces which gather fibrous waste. Some surfaces are smooth, some are nappy or otherwise contain hairs, bristles, and the like, which may be either straight or curly, and some are irregular or textured. Polished wood, tile, glass, and others are smooth. Rugs, carpets, and some fabrics have nap or fabric tassels. Plaster, cement, and other surfaces typically for walls are irregular or textured.

Because of this variation in household surface characteristics, the number of implements which can collect fibrous waste is limited. Vacuum devices are very effective, but must typically be wielded with a collection nozzle carefully placed progressively over the entire surface being cleaned.

Commercial products which pick up hair and lint from environmental surfaces have come into vogue in recent years. The most popularly sold products include hand held wands having cylindrical bodies adapted to capture fibrous waste by adherence. The cylindrical bodies may rotate on the handle or may be fixed to the handle. These tools are good for retaining fibrous wastes, but are limited by their cylindrical configuration. That is, the patch of contact between the cylindrical body and the surface being cleaned can be fairly small. Providing larger cylindrical bodies is not a satisfactory solution, since the larger body may interfere with environmental object and hence not be able to contact all of the surface being cleaned.

There remains a need for a fibrous waste collecting cleaning tool which avoids the limitations of popular prior art cleaning devices.

### SUMMARY OF THE INVENTION

The present invention provides a device which operates using the adherence principle, but which is better suited to increasing contact area with environmental surfaces being cleaned. The device comprises a structural stratum, a first surface which is textured to engage an object placed into contact therewith so as to oppose sliding of that object along the first surface, and an opposed second surface bearing a material which displays characteristics of light tack. Optionally, the second surface may be temporarily covered by a protective release liner.

In use, the device is placed onto an environmental surface which is to be cleaned of fibrous waste, with the tacky side of the device facing the environmental surface. If a release liner has been provided, it is removed prior to placing the device. The device is then lightly and briefly pressed against the environmental surface. Upon removing the device, most of the fibrous waste will remain with the device.

The amount of environmental surface area which is effectively cleaned thereby is not limited as occurs with cylindrical tools. Rather, the entire face of the device may be effectively utilized to gather waste.

The cost of the novel cleaning device is less than that of a device which must be made to cylindrical form and provided with a handle.

It is an object of the invention to provide a low cost uncomplicated device which effectively cleans an environmental surface of fibrous waste.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an exaggerated perspective view of a cleaning mat according to the present invention.

FIG. 2 is an exaggerated side view of a stack of cleaning mats such as that shown in FIG. 1, enclosed within retail packaging.

### DETAILED DESCRIPTION

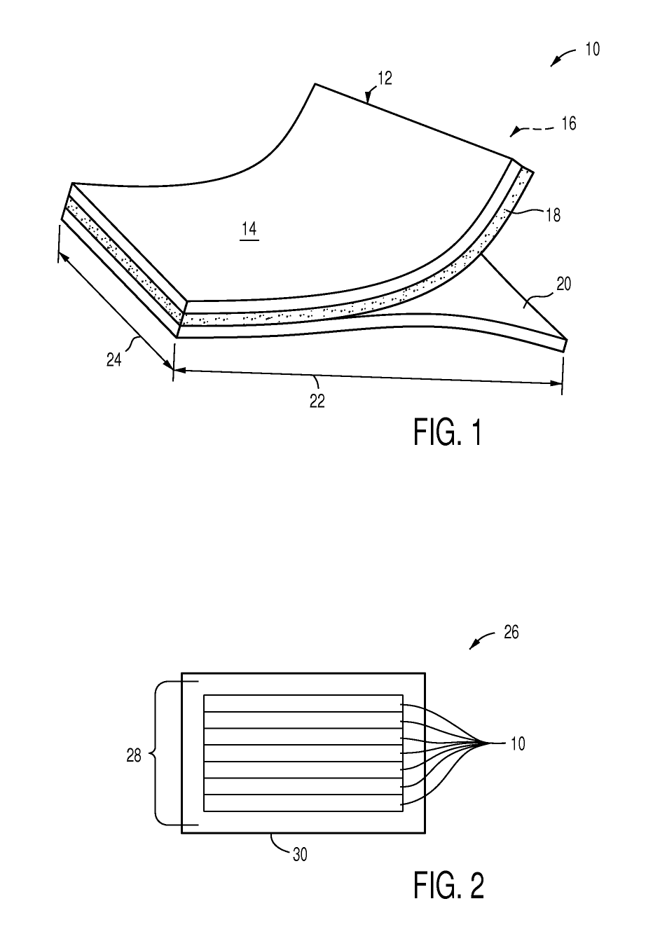

Referring to FIG. 1, the present invention contemplates a cleaning mat 10 for removing fibrous waste (not shown) from environmental surfaces. The cleaning mat 10 comprises a generally square web of plastic matting 12 having a front face 14, a rear face 16, a light tack adhesive layer 18 disposed on the rear face 16, and a removable and reinstallable liner 20 disposed on the light tack adhesive layer 18. As employed herein, the term “generally square” signifies that the length exceeds the width by no more than fifty percent. The plastic matting 12 provides a flexible structural stratum having a textured, mildly compressible upper surface due to compressibility of the constituent material. This constituent material may be a flexible polymeric open or closed cell foam for example. The term “reinstallable” signifies that the reinstallable liner 20 may be replaced against the adhesive layer 18 and after being pressed thereagainst by manual pressure, will be retained. The adhesive liner 18 may be subsequently removed for another use. This may be done for example where only a small amount of fibrous waste has been gathered, and the cleaning mat 10 has capacity to gather a significant or useful additional amount of fibrous waste. This avoids wasteful underutilization of each cleaning mat 10.

FIG. 1 depicts the reinstallable liner 20 as it would appear if partially peeled away from the light tack adhesive layer 18. Characteristics of the reinstallable liner 20 are selected to enable the reinstallable liner 20 to be removed from the light tack adhesive layer 18 manually, and retained after being reinstalled.

The cleaning mat 10 has a length 22 in the range of four to twelve inches and a width 24 in the range of four to twelve inches. This size is regarded as being appropriate with respect to being wielded and maneuvered by hand, being large enough to efficiently clean household and other environmental surfaces yet not so large as to be unwieldy when applied to ordinary furniture, and convenient for retail display and distribution, and storage in a residential setting. In one embodiment regarded as advantageous for being stored in drawers of furniture, in a purse, in a glove box of a motor vehicle, and like places (none shown), the length 22 and the width 24 may be in the range of four to six inches.

Referring to FIG. 2, the cleaning mat 10 may be provided in retail packages such as a retail package 26, which comprises a pad 28 of stacked individual cleaning mats 10, enclosed within suitable packaging 30 such as cellulosic film, heavy paper, light cardboard (none shown) or other inexpensive packaging materials.

Of course, the shape of each cleaning mat 10 may be varied from square and rectangular as performance is for most tasks not dependent upon shape. However, in some embodiments, each cleaning mat 10 may be formed to include a very narrow projection or tail (not shown) which could for example be pressed into a crevice or other area of restricted access in furniture.

The cleaning mat 10 may be used according to the following method. The method may include steps of providing a cleaning mat such as the cleaning mat 10, manually peeling away the liner 20 if that has not already been done, placing the cleaning mat 10 onto an environmental surface, pressing the cleaning mat 10 against the environmental surface, and removing the cleaning mat 10 from the environmental surface. Ordinary forms of fibrous waste such as lint from clothes and other fabrics, hair from animals and people, and similar waste will spontaneously adhere to the light tack adhesive layer. In some cases, casual contact will not capture fibrous waste. The following procedure will improve capture of fibrous waste. The procedure comprises a step of manually pressing the cleaning mat 10 against the environmental surface in a motion which has a first orthogonal component which is perpendicular to the cleaning mat 10 and a second orthogonal component which is parallel to the cleaning mat 10. Alternatively stated, the user must press in a motion which presses the cleaning mat 10 directly against the surface being cleaned and which also would advance the cleaning mat 10 along the surface being cleaned if not opposed by friction. This procedure may be followed for both planar and curved environmental surfaces. When utilized with curved environmental surfaces, pressure imposed on the cleaning mat 10 against the surface being cleaned must be sufficient to cause the cleaning mat 10 to conform to the curved environmental surface. This procedure will typically produce satisfactory performance in capturing fibrous waste from fabric surfaces, such as upholstered furniture (not shown), and even with nappy surfaces (not shown), which nappy surfaces ordinarily have a propensity to retain fibers.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. A method of removing fibrous waste from environmental surfaces, comprising the steps of:
providing a cleaning mat comprising a flexible structural stratum having a textured, mildly compressible upper surface and an opposed second surface which bears a light tack substance;
placing the cleaning mat onto an environmental surface;
pressing the cleaning mat against the environmental surface; and
removing the cleaning mat from the environmental surface.

2. The method of claim 1, wherein the step of pressing the cleaning mat comprises the further step of manually pressing the cleaning mat against the environmental surface in a motion which has a first orthogonal component which is perpendicular to the cleaning mat and a second orthogonal component which is parallel to the cleaning mat.

3. The method of claim 2, wherein the step of placing the cleaning mat comprises the further step of placing the cleaning mat against a curved environmental surface, and the step of pressing the cleaning mat comprises the further step of pressing the cleaning mat against the curved environmental surface such that the cleaning mat conforms to the curved environmental surface.

4. The method of claim 3, wherein the curved environmental surface is nappy.

5. The method of claim 3, wherein the curved environmental surface comprises a fabric.

6. A cleaning mat for removing fibrous waste from environmental surfaces, comprising a generally square web of plastic matting having a front face, a rear face, a light tack adhesive layer disposed on the rear face, and a removable and reinstallable liner disposed on the light tack adhesive layer, wherein the cleaning mat has a length in the range of four to twelve inches and a width in the range of four to twelve inches.

7. The cleaning mat of claim 6, wherein the length is in the range of four to six inches and the width is in the range of four to six inches.
